(19) United States
(12) Patent Application Publication
(10) Pub. No.: US 2011/0119058 A1
(43) Pub. Date: May 19, 2011

(54) METHOD AND SYSTEM FOR THE CREATION OF A PERSONALIZED VIDEO

(75) Inventors: Alexandre Berard, Longueuil (CA); Michel Sofia, Montreal (CA)

(73) Assignee: 4419341 CANADA, INC., QUEBEC (CA)

(21) Appl. No.: 12/747,471

(22) PCT Filed: Dec. 10, 2008
(86) PCT No.: PCT/CA2008/002175

§ 371 Date: Jan. 18, 2011

Related U.S. Application Data
(60) Provisional application No. 60/996,890, filed on Dec. 10, 2007.

(51) Int. Cl. H04N 9/80; G10L 15/00; G10L 13/08; G10L 15/26

(52) U.S. Cl. 704/235; 386/248; 704/231; 704/260; 386/E09.011; 704/E15.001; 704/E15.043; 704/E13.011

(57) ABSTRACT

A method and system for creating a personalized video destined to an intended recipient, comprising gathering personal information about the intended recipient, selecting of a non personalized video, retrieving the selected non personalized video along with associated customizable elements, setting the customizable elements according to the personal information of the intended recipient and assembling the non personalized video and the set customizable elements to create the personalized video.

### TECHNICAL FIELD

The present invention relates to a method and system for the creation of a personalized video.

### BACKGROUND

Numerous cards, such a greeting or special occasion cards, have been available in an electronic format accessible via the Internet, with a variety of different decorative images and messages thereon. Such cards often have some sort of predetermined animation included therein.

Prior art electronic cards, however, have only very limited personalization which often limits itself to the inclusion a recipient name, a text message and a sender name, all in a textual format.

Similarly, although targeted advertisement is commonly available, its only personalization lies in its general target group, i.e. age group, income range, gender, etc., it does not relate directly to the specific target viewing the advertisement.

Thus, a need exists for an improved personalization method that overcomes the disadvantages of the prior art.

### SUMMARY

According to an illustrative embodiment of the present invention, there is provided a method for creating a personalized video destined to an intended recipient, comprising:
gathering personal information about the intended recipient;
selecting of a non personalized video;
retrieving the selected non personalized video along with associated customizable elements;
setting the customizable elements according to the personal information of the intended recipient; and
assembling the non personalized video and the set customizable elements to create the personalized video.

According to another illustrative embodiment of the present invention, there is provided a system for creating a personalized video destined to an intended recipient, comprising:
a content database containing at least one non personalized video and at least one customizable element associated with the at least one non personalized video;
a multimedia server operatively connected to the content database, the multimedia server being so configured so as to:
   gather personal information about the intended recipient;
   select a non personalized video from the content database based on the personal information about the intended recipient;
   retrieve the selected non personalized video along with the at least one customizable element associated with the selected non personalized video from the content database;
   set the at least one customizable element associated with the selected non personalized video according to the personal information of the intended recipient;
   assemble the selected non personalized video and the set customizable elements associated with the selected non personalized video to create the personalized video.

### BRIEF DESCRIPTION OF THE FIGURES

Embodiments of the invention will be described by way of example only with reference to the accompanying drawings, in which:

FIG. 1 is a schematic view of computing devices connected to a personalized internet video system through a network;

FIG. 2 is a flow diagram depicting an illustrative example of a process of a user accessing personalized internet video system;

FIG. 3 is a flow diagram depicting an illustrative example of a video creation process;

FIG. 4 is a schematic view of a webpage displaying personalized targeted video advertisement; and

FIG. 5 is a flow diagram depicting an illustrative example of a personalized targeted advertisement video creation process.

### DETAILED DESCRIPTION

Generally stated, the non-limitative illustrative embodiment of the present invention provide a method and system for the creation of a personalized video, for example, a personalized Christmas video destined to an intended recipient and accessible, for example, through a network. It is to be understood that throughout the following disclosure, the term video also applies to a video clip, an animation such as, for example, a Flash™ animation, a 2D or 3D animation, etc.

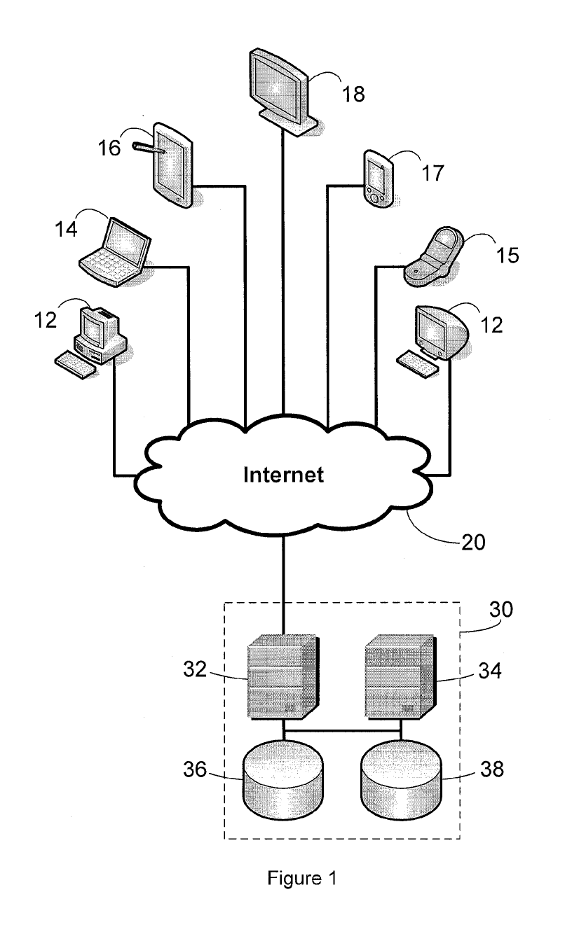

Referring to FIG. 1, a user using a personal computer 12, laptop computer 14, a cell phone 15, a tablet computer 16, a personal assistant device 17, a kiosk 18, or any other such computing device, on which can run a web browser application, a Flash™ interface, or any other such interface or information exchange application, may access the video personalization system 30 through the access server 32 via an Internet connection 20 such as, for example, Ethernet (broadband, high-speed), wireless WiFi, cable Internet, satellite connection, cellular or satellite network, etc. Further to the access server 32, the video personalization system 30 includes a multimedia server 34, a content database 36 and a personal information database 38, all of which will be detailed further below.

In the following description, for the purpose of clarity, the use of a personal computer 12 should be construed as to represent as well a laptop computer 14, a cell phone 15, a tablet computer 16, a personal assistant device 17, a kiosk 18, or any other such computing device, on which can run a web browser application, a Flash™ interface, or any other such interface or information exchange application.

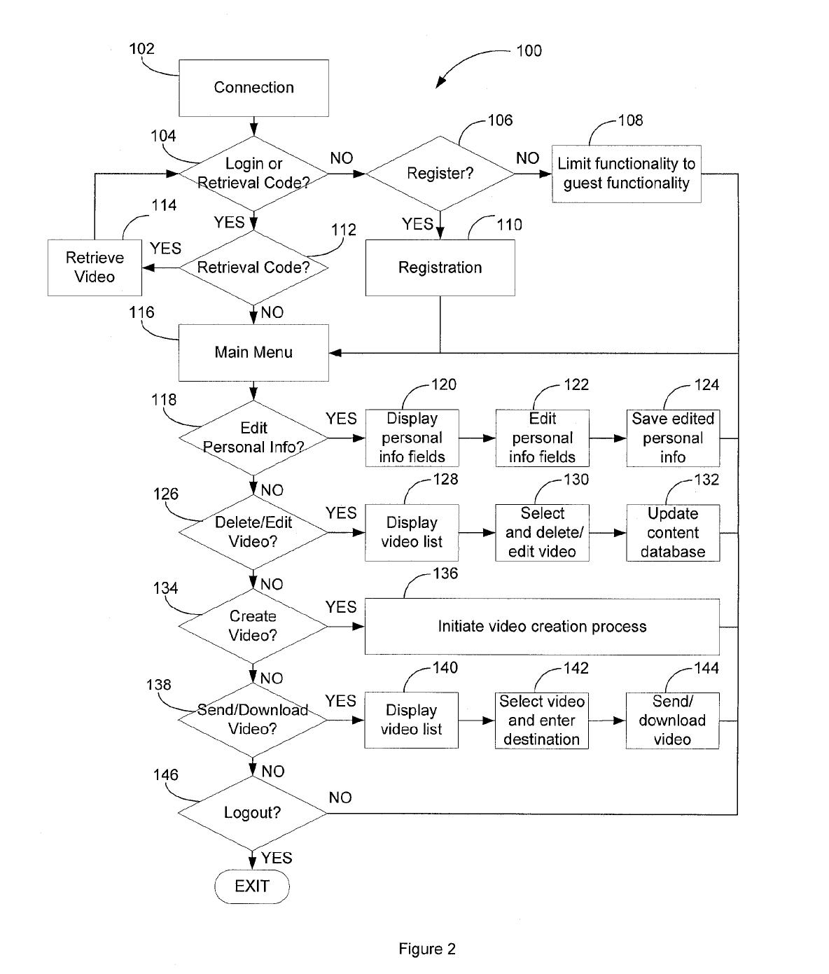

Referring now to FIG. 2, there is shown a flow diagram of an illustrative example of a process 100 executed when a user accesses the video personalization system 30. The steps of the process 100 are indicated by blocks 102 to 146.

The process 100 starts at block 102 where the user connects to the connection server 32 (see FIG. 1) using a personal computer 12 on which runs a browser application.

At block 104, the user is given the opportunity to log into the video personalization system 30 using an assigned login and password or a retrieval code, which will be detailed further below. If the user logs in, the connection server 32 validates the login and password of the user, or the retrieval code, by querying the personal information database 38. If the user is registered or the retrieval code is valid, the personal information database 38 sends back information associated with the user such as, for example, the user profile, preferences, etc., or one or more references to saved personalized videos in the content database 36, and then proceeds to block 112.

If the user does not log in it is given the opportunity, at block 106, to register into the video personalization system 30. If the user chooses to register, the process 100 proceeds to block 110 where the user registers into the video personalization system 30 and then proceeds to block 116. If the user chooses not to register, the process 100 limits, at block 108, the functionality of the video personalization system 30 to guest functionality for that user and then proceeds to block 116.

A block 112, the process 100 verifies if the user has entered a retrieval code and if so, at block 114, retrieves the associated video (or link to the associated video) from the content database 36 and displays it to the user. The user may then be given the opportunity to save the retrieved video to its personal computer 12 if that option is made available to it. The process 100 then proceeds back to block 104. If the user has not entered a retrieval code, the process 100 proceeds to block 116.

Then, at block 116, the process 100 displays a main menu where the user may select various options, such as, for example, edit personal information, delete/edit a video or create a new video.

At block 118, the process 100 verifies if the user has selected to edit its personal information such as, for example, password, name, email, etc. If so, at block 120, the process 100 displays the personal information fields related to the user. Then, at block 122, the user edits its information in the displayed fields and, at block 124, the edited personal information is saved in the personal information database 38. The process 100 then returns to block 116.

At block 126, the process 100 verifies if the user has selected to delete/edit a video. If so, at block 128, the process 100 displays a list of user created videos stored in the content database 36, after which the user selects, at block 130, a video and deletes/edits it. The process 100 then updates, at block 132, the content database 36 and then returns to block 116.

At block 134, the process 100 verifies if the user has selected to create a new personalized video. If so, at block 136, the video creation process is initiated, after the completion of which the process 100 returns to block 116. The personalized video creation process will be further detailed below.

At block 138, the process 100 verifies if the user has selected to send/download a video. If so, at block 140, the process 100 displays a list of user created videos stored in the content database 36. The user then selects, at block 142, a video and enters the video's destination, e.g. email address of the intended recipient, a mail address of the intended recipient or a download path on the user's personal computer 12. Then, at block 144, the process 100 either sends a copy of the video, a link to the video stored in the content database 36 or a retrieval code associated with the video by email, or sends a CD/DVD version of the video via mail. It is to be understood that other means of transmission may be used such as, for example, fax (in the case of a link or retrieval code) or a memory bar in the case of a video itself. It is also to be understood that the video format may vary and that the video may be viewed, depending on its format, on a web browser application, a Flash™ interface, a proprietary viewer or a publicly available viewer. The process 100 then returns to block 116.

Finally, at block 146, the process 100 verifies if the user has selected to logout from the video personalization system 30. If so, the process 100 exits, otherwise it proceeds back to block 116.

It is to be understood that certain functionalities may be restricted to specific users or types of users. For example, guest users may not be allowed to send and/or download a video. It is also to be understood that certain functionalities may be optional and not necessarily provided by the video personalization system 30 or that further functionalities may be added.

It is also to be understood that the video personalization system 30 may be used without the login/registration and/or retrieval steps described at blocks 104 to 114 of FIG. 2. In this case, a user would simply connect to the system at block 102 and access the main menu directly at block 116.

It is further to be understood that the process 100 may include a payment sub-process in order to charge users for creating a personalized video.

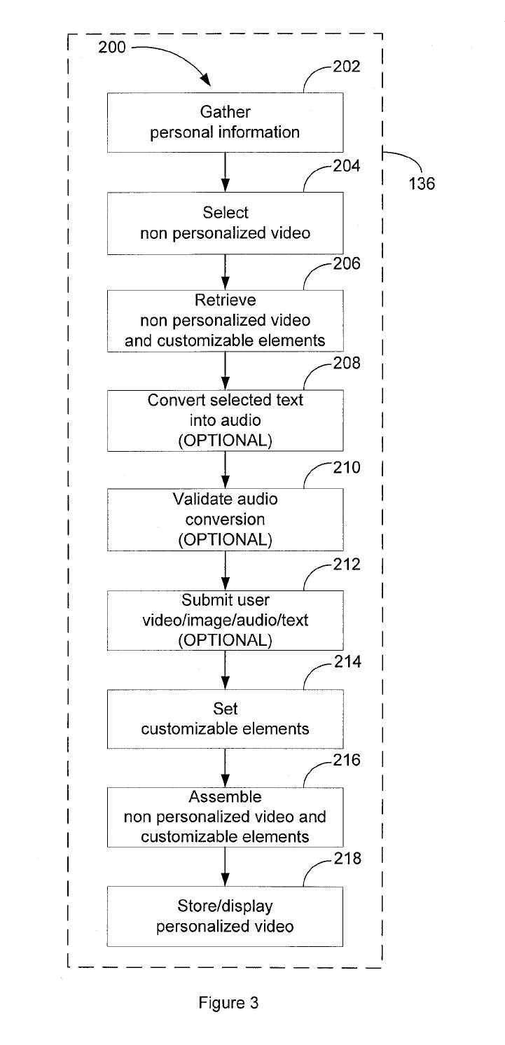

Referring to FIG. 3, there is shown a flow diagram of an illustrative example of a personalized video creation process 200 executed by the video personalization system 30 at block 136 of process 100 (see FIG. 2), in order to produce a new personalized video. The steps of the process 200 are indicated by blocks 202 to 218 and may be executed, for example, by the multimedia server 34.

The process 200 starts at block 202 where personal information about the intended recipient of the video is gathered. The information may be provided by the user, by a third party, stored in the personal information database 38 or gathered from a profile (for example from a database or from another source). The personal information may be provided using a form where the user answers questions by selecting an answer in the form of a text, a video, an audio and/or image from a list, providing a text, a video, an audio and/or an image, or a combination thereof. Alternatively, some or all of the answers to the questions of the form may be selected and/or information provided using a voice recognition sub-process. Furthermore, audio provided using the recognition sub-process may be further process so as to modify the voice of the user to correspond to a desired voice for the personalized video.

It is to be understood that personal information about the user or the intended recipient may be provided via other means such as by mail, email, fax, telephone, SMS, MMS, WAP, VOD, portable memory device, etc.

It is to be understood that the intended recipient may be the user itself or someone else.

At block 204, a non personalized video is selected. The non personalized video may be predetermined, selected by the user or selected by the video personalization system 30 in accordance with the personal information of the intended recipient.

Following which, at block 206, the process 200 retrieves the non personalized video, along with associated customizable elements, from the content database 36. The customizable elements may be video, image, audio and/or text elements to be inserted in the non personalized video at predetermined positions.

Optionally, at block 208, the user may select text that is to be converted as audio within the personalized video as one or more of the customizable elements or, alternatively, the process 200 may automatically select some text fields from the gathered personal information of the intended recipient of the personalized video that are to be converted as audio as one or more of the customizable elements. For example, the name of the intended recipient may be converted into audio. The process 200 verifies if the text is present in the content database 36 or, optionally, in a third party database, and if not, it generates an audio version of the text using, for example, a text-to-speech sub-process. It is to be understood that in an alternative embodiment, the text-to-speech sub-process may be provided by a third party server.

Then, optionally still, at block 210, the process 200 may validate the audio rendition of the text with the user. If the conversion is incorrect, the process 200 may repeat the text-to-speech sub-process by, for example, giving indications to the user as to how to phonetically write the text and repeat the text-to-speech sub-process until the user is satisfied or decides not to convert the text into audio.

In yet another optional step, at block 212, the user may have the option to submit its own text, video, audio and/or image elements, to be included in the video as one or more of the customizable elements. Alternatively, some or all of the textual elements may be provided using a voice recognition sub-process. Furthermore, audio may be provided using the voice recognition sub-process and further processed so as to modify the voice of the user to correspond to a desired voice for the personalized video.

At block 214, the process 200 sets the customizable elements according to the personal information of the intended recipient (for example text to be included in a book image within the video, an audio message saying the name of the intended recipient's name, a Christmas gift list where the listed items are gathered from the personal information of the intended recipient, etc.). Optionally, if the user used the text-to-speech functionality from block 206 and/or the submission of video, image, photos, audio, music or text functionality from block 210, these elements may also be used to set the customizable elements.

Then, at block 216, the process 200 assembles the non personalized video and the customizable elements, as set at block 214, so as to form a single video which has been personalized with gathered information about the intended recipient.

Finally, at block 218, the process 200 may save the assembled personalized video into the content database 36 and provide a retrieval code associated with the personalized video to allow its subsequent retrieval from the content database 36. The personalized video may also be displayed to the user so as to allow it to go back and modify some customizable elements should it not be satisfied with the resulting personalized video. Alternatively, the resulting personalized video may simply be displayed to the user, for example in the case of a guest user, without saving it to the content database 36.

It is to be understood that although process 200 has been described in the context of its execution by the video personalization system 30 at block 136 of process 100 of FIG. 2, it may also be used on its own in the context of, for example, the creation of personalized targeted advertisement on a webpage (an example of which will be presented further below), a cell phone, direct marketing via email, etc.

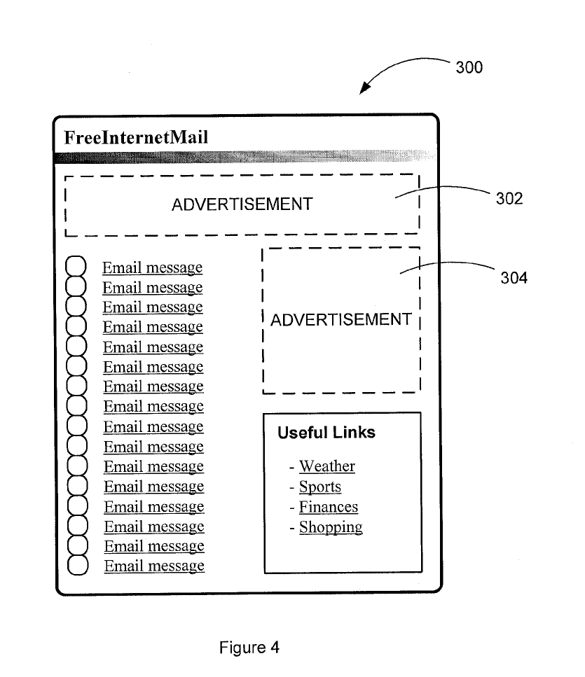

Referring to FIG. 4, there is shown and example of a webpage 300 having therein display areas 302 and 304, which may be used to display personalized targeted video advertisement. When a user accesses the webpage 300, a personalized targeted video advertisement process is executed so as to provide advertisement in the form of a personalized video targeted to the user. For example, a personalized marquis type animation header may be displayed in display area 302 while a personalized video similar to a television commercial may be displayed in display area 304. It is to be understood that the layout of the webpage 300 and the content of display areas 302 and 304 are meant as examples only and that other layout configurations and/or content are possible.

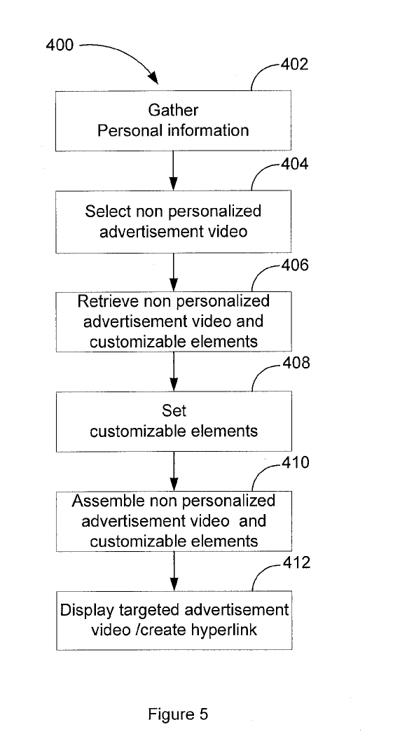

Referring now to FIG. 5, there is shown a flow diagram of an illustrative example of a personalized targeted video advertisement process 400 executed when the user accesses the webpage 300 of FIG. 4 in order to provide a personalized targeted advertisement video. The steps of the process 400 are indicated by blocks 402 to 412. The webpage 300 may be located on the access server 32 of the video personalization system 30, in which case the process 400 is executed by the multimedia server 34, it may be located on a third party server, in which case the process 400 may be executed by the third party server displaying the webpage 300 or it may be executed remotely by the multimedia server 34. However, for clarity and conciseness, the following description will assume that the webpage 300 is located on the access server 32 of the video personalization system 30.

The process 400 starts at block 402 where personal information about the user accessing the webpage 300 is gathered. The information may be provided by a third party, stored in the personal information database 38 in the case where the user is registered or gathered from a profile (for example from a database, from a browsing analysis agent or from another source).

At block 404, a non personalized advertisement video is selected. The non personalized advertisement video may be predetermined or selected by the video personalization system 30 in accordance with the personal information of the intended recipient, contextually selected, i.e. the type of information provided by the webpage 300, or from a profile of the average user accessing the webpage 300.

At block 406, the process 400 retrieves the non personalized advertisement video, along with associated customizable elements, from the content database 36. The customizable elements may be video, image, audio and/or text elements to be inserted in the non personalized advertisement video at predetermined positions.

Then, at block 408, the process 400 sets the customizable elements according to the personal information of the user accessing the webpage 300 (for example a car of a user's preferred color, text to be included in a poster image within the video, a personalized audio track describing a product, etc.). The personalized audio track may, for example, address the user by its name, mention the location of the user (city, state/province, country), provide audio information varying on the location of the user, etc.

Following which, at block 410, the process 400 assembles the non personalized advertisement video and the customizable elements, as set at block 408, so as to form a single targeted advertisement video which has been personalized with gathered information about the user accessing the webpage 300.

Finally, at block 412, the process 400 displays the assembled personalized targeted advertisement video in its designated display area 302 or 304 and may optionally create a hyperlink linking the personalized targeted advertisement video to, for example, the website of the advertiser.

It is to be understood that although the personalized targeted video advertisement process 400 has been described in the context of a webpage 300 requesting a targeted advertisement video, the same process may be used in other contexts where a targeted advertisement video is desired and where personal information about a potential customer is available. For example, in the case of direct marketing, personal information about a potential customer is provided to the targeted video advertisement process 400, which produces a targeted video advertisement that can then be emailed, or a hyperlink to it, to the potential customer.

It is to be understood that there may be added blocks or variations in the ordering of the blocks of processes 100, 200 and 400 without departing from the scope of the present invention.

It is further to be understood that although throughout the disclosure reference is made to separate servers 32 and 34 as well as separate databases 36 and 38, these may be implemented on one or more physical device and/or may be combined.

Although the present invention has been described by way of particular embodiments and examples thereof, it should be noted that it will be apparent to persons skilled in the art that modifications may be applied to the present particular embodiments without departing from the scope of the present invention.

1. A method for creating a personalized video destined to an intended recipient, comprising:
gathering personal information about the intended recipient;
selecting of a non personalized video;
retrieving the selected non personalized video along with associated customizable elements;
setting the customizable elements according to the personal information of the intended recipient; and
assembling the non personalized video and the set customizable elements to create the personalized video.

2. A method according to claim 1, wherein the video is selected from a group consisting of a video clip, a Flash™ animation, a 2D animation and a 3D animation.

3. A method according to claim 1, wherein the information about the intended recipient is gathered from a source selected from the group consisting of a user, a database, a browsing analysis agent.

4. A method according to claim 3, wherein the information about the intended recipient is gathered using a form where the user answers questions by selecting an answer in the form of a text, a video, an audio, an image or a combination thereof from a list.

5. A method according to claim 3, wherein the information about the intended recipient is gathered from a user providing a text, a video, an audio, an image or a combination thereof.

6. A method according to either of claim 5, wherein the information about the intended recipient is provided by the user using voice recognition.

7. A method according to claim 6, wherein audio information about the intended recipient is processed such as to modify the voice of the user to correspond to a desired voice.

8. A method according to claim 1, wherein the non personalized video is predetermined, selected by the user, selected in accordance with the personal information of the intended recipient or contextually selected.

9. A method according to claim 1, wherein the customizable elements are video, image, audio, text, or a combination thereof, to be inserted in the non personalized video at predetermined positions.

10. A method according to claim 9, further comprising obtaining from a user a text element, a video element, an audio element or an image element to be included as one of the customizable elements.

11. A method according to claim 9, further comprising selecting text to be included as one of the audio customizable element and converting the selected text into audio.

12. A method according to claim 10, further comprising verifying if the audio conversion of the selected text is correct and if not, giving instructions to as to how phonetically write the selected text, obtaining a new text and converting the new text to audio.

13. A method according to claim 9, further comprising a user selecting a text field of the personal information about the intended recipient to be included as one of the audio customizable element and converting the selected text into audio.

14. A method according to claim 12, further comprising verifying if an audio version of the selected text field exists in a database and if not, converting the selected text field into audio.

15. A method according to claim 12, further comprising verifying if the audio conversion of the selected text field is correct and if not, giving instructions to as to how phonetically write the selected text field, obtaining a new text field and converting the new text field to audio.

16. (canceled)

17. (canceled)

18. A method according to claim 1, further comprising sending the personalized video to the intended recipient.

19. A method according to claim 1, further comprising saving the personalized video in a database.

20. A method according to claim 19, further comprising providing a retrieval code associated with the personalized video to allow its subsequent retrieval from the database.

21. A method according to claim 20, further comprising sending the retrieval code to the intended recipient.

22. A method according to claim 19, further comprising providing a hyperlink to the personalized video.

23. A method according to claim 22, further comprising sending the hyperlink to the intended recipient.

24. (canceled)

25. A system for creating a personalized video destined to an intended recipient, comprising:
a content database containing at least one non personalized video and at least one customizable element associated with the at least one non personalized video;
a multimedia server operatively connected to the content database, the multimedia server being so configured so as to:
gather personal information about the intended recipient;
select a non personalized video from the content database based on the personal information about the intended recipient;
retrieve the selected non personalized video along with the at least one customizable element associated with the selected non personalized video from the content database;
set the at least one customizable element associated with the selected non personalized video according to the personal information of the intended recipient;
assemble the selected non personalized video and the set customizable elements associated with the selected non personalized video to create the personalized video.

26. A system according to claim 25, wherein the multimedia server comprises a voice recognition sub-process for converting audio into text.

27. A system according to claim 25, wherein the multimedia server comprises a text-to-speech sub-process for converting selected text into audio.
